(19) United States
(12) Patent Application Publication
(10) Pub. No.: US 2019/0089141 A1
(43) Pub. Date: Mar. 21, 2019

(54) SPLICE PLATE WITH SPACING INDICIA FOR CABLE TRAY SECTION SPACING

(71) Applicant: Cooper Technologies Company, Houston, TX (US)

(72) Inventors: Matthew T. Combes, Greenville, IL (US); Nicholas R. Grahek, Highland, IL (US); Alexander W. Schickling, Edwardsville, IL (US); Robert J. Reese, Edwardsville, IL (US)

(73) Assignee: Cooper Technologies Company, Houston, TX (US)

(21) Appl. No.: 15/711,476

(22) Filed: Sep. 21, 2017

(51) Int. Cl. H02G 3/06

(52) U.S. Cl. CPC H02G 3/0608

(57) ABSTRACT

A splice plate for a cable tray facilitates proper longitudinal spacing between first and second cable tray sections. The splice plate may include spacing indicia that indicates to a user longitudinal spacing between the longitudinal ends of the first and second cable tray sections when the splice plate is fastened to the first and second cable tray sections. The splice plate may include a window that allows at least one of the longitudinal ends of the respective first and second cable tray sections to be visible when the splice plate is fastened to the first and second cable tray sections. The splice plate may include a machine readable marking including a machine readable representation of a web address that directs a hand-held device including a processor to a webpage including instructions for using the splice plate.

### FIELD OF THE DISCLOSURE

The present disclosure generally relates to a splice plate, such as an expansion splice plate, including spacing indicia to facilitate proper longitudinal spacing of spliced cable tray sections.

### BACKGROUND OF THE DISCLOSURE

A cable tray, such as a ladder cable tray, is used by industry to support electrical cable. A length or section of the ladder cable tray comprises a pair of side rails connected by cable-supporting rungs extending between the rails at intervals along the tray. Cable tray sections are spliced together using splice plates to form a cable tray run. One type of splice plate is an expansion splice plate. Expansion splice plates are particularly useful when installing the cable tray run outdoors where temperature variations may cause thermal expansion and contraction of the cable tray sections. According to industry standards, the adjacent longitudinal ends of the cable tray sections spliced together using an expansion splice plate are spaced apart a required longitudinal distance to allow for thermal expansion and contraction of the cable tray sections.

### SUMMARY OF THE DISCLOSURE

In at least one aspect, a splice plate for a cable tray facilitates proper longitudinal spacing between first and second cable tray sections.

In one aspect, a splice plate for splicing together longitudinal ends of respective first and second cable tray sections to form a cable tray run has opposite first and second longitudinal ends and a length extending therebetween. The splice plate generally comprises a plate body having opposite inboard and outboard faces. A first fastener opening extends through the inboard and outboard faces of the plate body. The first fastener opening is configured to receive a first fastener to fasten the splice plate to the first cable tray section. A second fastener opening extends through the inboard and outboard faces of the plate body. The second opening is spaced apart from the first fastener opening along the length of the splice plate. The second fastener opening is configured to receive a second fastener to fasten the splice plate to the second cable tray section. Spacing indicia is configured to indicate to a user longitudinal spacing between the longitudinal ends of the first and second cable tray sections when the splice plate is fastened to the first and second cable tray sections.

In another aspect, a splice plate for splicing together longitudinal ends of respective first and second cable tray sections to form a cable tray run has opposite first and second longitudinal ends and a length extending therebetween. The splice plate generally comprises a plate body having opposite inboard and outboard faces. A first fastener opening extends through the inboard and outboard faces of the plate body. The first fastener opening is configured to receive a first fastener to fasten the splice plate to the first cable tray section. A second fastener opening extends through the inboard and outboard faces of the plate body. The second opening is spaced apart from the first fastener opening along the length of the splice plate. The second fastener opening is configured to receive a second fastener to fasten the splice plate to the second cable tray section. A window is configured to allow at least one of the longitudinal ends of the respective first and second cable tray sections to be visible therethrough when the splice plate is fastened to the first and second cable tray sections.

### BRIEF DESCRIPTION OF THE DRAWINGS

FIG. 1 is a perspective of a ladder cable tray including two cable tray sections and splice plates splicing together the two cable tray sections;

FIG. 2 is similar to FIG. 1 with one of the splice plates exploded from the cable tray sections;

FIG. 3 is a cross section of the splice plate, including a rail of one of the cable tray sections shown in broken lines;

FIG. 4 is a partial front elevation of the cable tray sections adjacent one another before splicing;

FIG. 5 is a front elevation of the splice plate;

FIG. 6 is an enlarged, partial view of FIG. 5;

FIG. 7 is an enlarged, partial front elevation of the ladder cable tray of FIG. 1, with longitudinal ends of the first and second cable tray sections slightly spaced apart or abutting;

FIG. 8 is similar to FIG. 7, with the longitudinal ends of the first and second cable tray sections spaced apart a first distance;

FIG. 9 is similar to FIG. 8, with the longitudinal ends of the first and second cable tray sections spaced apart a second distance;

FIG. 10 is a perspective of the splice plate splicing the first and second cable tray sections in a different orientation;

FIG. 11 is an enlarged, partial front elevation of another embodiment of a splice plate;

FIG. 12 is a front elevation of another embodiment of a splice plate;

FIG. 13 is an enlarged, partial front elevation of the splice plate of FIG. 12;

FIG. 14 is an enlarged, partial front elevation of another embodiment of a splice plate;

FIG. 15 is an enlarged, partial front elevation of another embodiment of a splice plate;

FIG. 16 is a perspective of another embodiment of a splice plate;

FIG. 17 is an enlarged, partial front elevation of the splice plate of FIG. 16;

FIG. 18 is a perspective of another embodiment of a splice plate;

FIG. 19 is an enlarged, partial front elevation of the splice plate of FIG. 18;

FIG. 20 is a front elevation of another embodiment of a splice plate;

FIG. 21 is a perspective of another embodiment of a splice plate;

FIG. 22 is an enlarged, partial top plan view of the splice plate of FIG. 21;

FIG. 23 is an enlarged, partial perspective of the splice plate of FIG. 21 splicing together two cable tray sections; and

FIG. 24 is an enlarged, partial top plan view of FIG. 24.

### DETAILED DESCRIPTION OF THE DISCLOSURE

In general, a splice plate (e.g., an expansion splice plate) designed and constructed according to the teachings of the present disclosure facilitates proper longitudinal spacing between the longitudinal ends of spliced cable tray sections. For example, in one or more embodiments, the splice plate includes spacing indicia for indicating to the user the longitudinal spacing between longitudinal ends spliced cable tray sections. In a particular non-limiting example, the splice plate may include a window to allow the user to align the longitudinal ends of the cable tray sections with the spacing indicia adjacent the windows so that the cable tray sections have the desired longitudinal spacing after splicing. In another non-limiting example, the splice plate may include the window, but not the spacing indicia, to allow one or both of the longitudinal ends of the cable tray sections to be visible through the window.

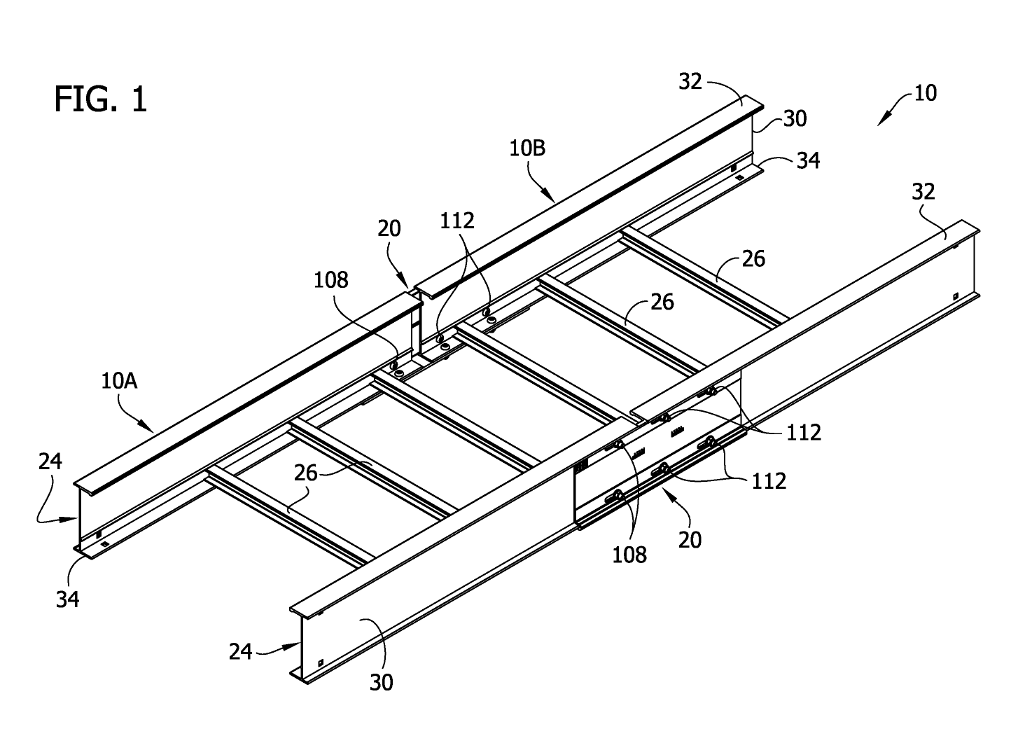

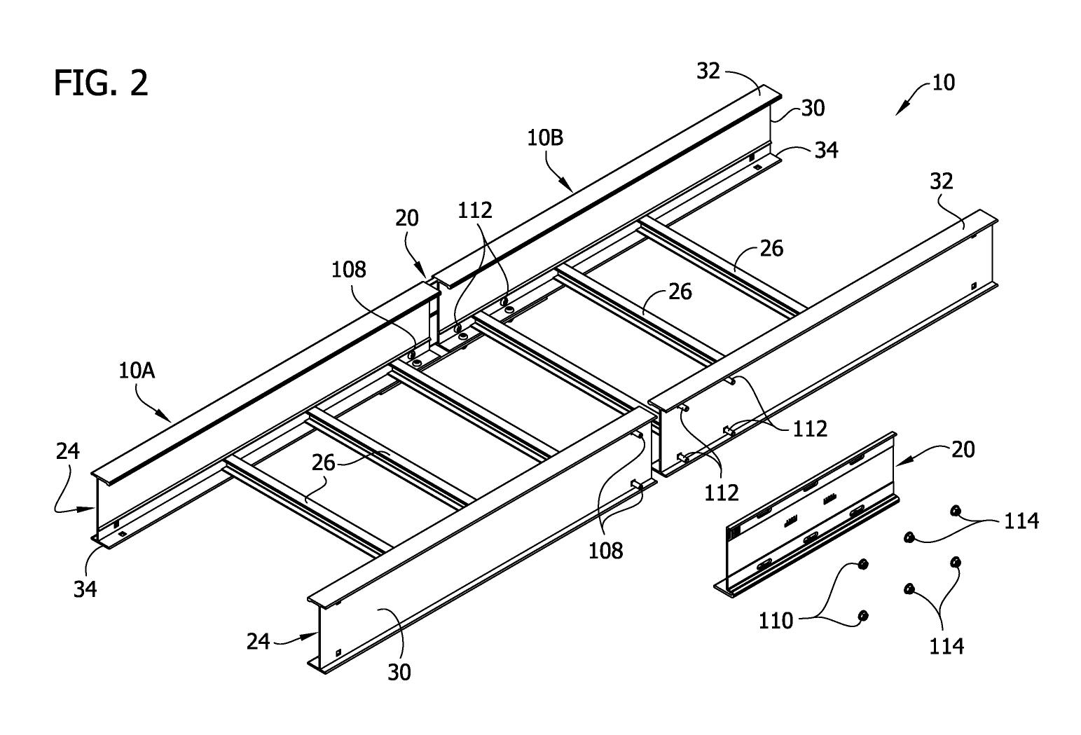

Referring to FIGS. 1 and 2, a ladder cable tray, generally indicated at reference numeral 10, includes first and second cable tray sections, generally indicated at reference numerals 10A, 10B, connected (i.e., spliced together) by splice plates, generally indicated at reference numeral 20 (e.g., expansion splice plates), which are constructed according to the teachings of the present disclosure. As used herein, terms denoting relative locations and positions of components and structures of the cable tray 10 and the splice plate 20, including but not limited to “upper,” “lower,” “left,” “right,” “front,” and “rear,” are in reference to the cable tray and the splice plate in the horizontal orientation, as shown in FIGS. 1 and 2 and through the drawings. It is understood that these terms are used for ease of description and are not meant to be used in a limiting sense. It is understood that the cable tray 10 and the splice plate 20 may be in a vertical orientation in the field, whereby the relative locations and positions of the components and structures would be different than as shown in the drawings. As used herein, the term “inboard” means toward or in the interior of the cable tray 10 in use, such as when the splice plate 20 is secured to the cable tray sections 10A, 10B. As used herein, the term “outboard” means away from the interior or at the exterior of the cable tray 10 in use, such as when the splice plate 20 is secured to the cable tray sections 10A, 10B.

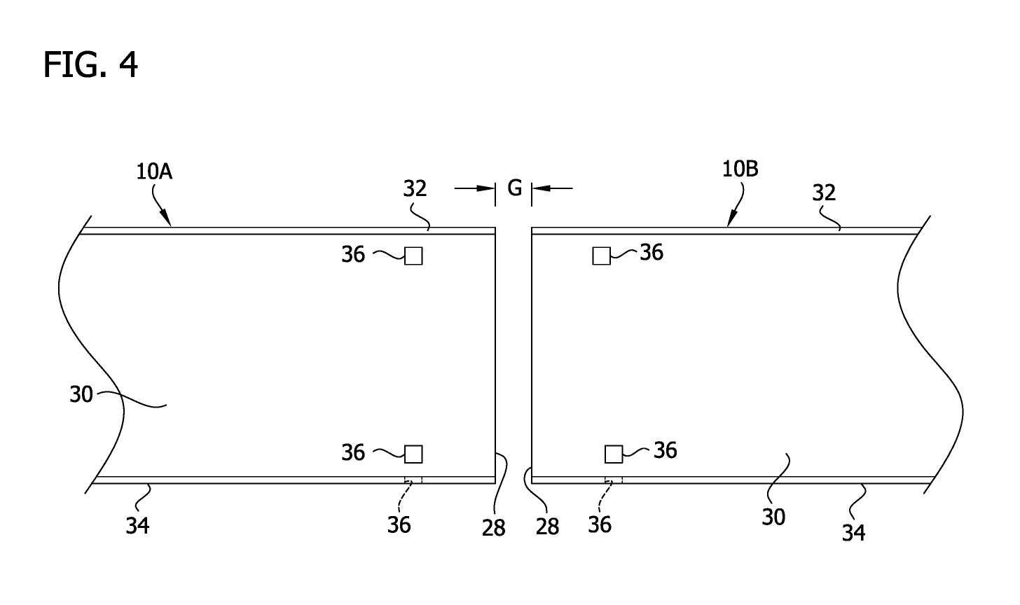

Each cable tray section 10A, 10B includes two parallel rails 24 forming the sides of the cable tray section, and a plurality of cable-supporting rungs, generally indicated at reference numeral 26, extending between and interconnecting the rails 24 at intervals spaced lengthwise of the section. Each rail 24 has a length extending between opposite longitudinal ends 28. Each rail comprises a generally vertical web 30, an upper generally horizontal flange 32 at the upper end of the web, and a lower generally horizontal flange 34 at the lower end of the web. The rungs 26 are secured (e.g., by welding or fasteners) to inboard portions of the lower flanges 34 extending inboard from respective webs. Pre-formed (e.g., pre-drilled) fastener openings or holes 36, such as shown in FIG. 4, are provided adjacent the opposite longitudinal ends 28 of the rails 24 for use in connecting the cable tray sections 10A, 10B to one another via the splice plates 20, as will be described. In the illustrated embodiment, each rail 24 has three pre-drilled holes adjacent each of its ends 28. Two of the three holes 36 are in the web 30 of the rail 24, and one of the holes 36 is in the outboard portion of the lower flange 34. All three holes 36 lie substantially in the same vertical plane. This arrangement, including the number of holes, can vary. The length of each manufactured cable tray section 10A, 10B may also vary (e.g., from 10-30 feet). Moreover, the longitudinal distance from the holes 36 to the adjacent longitudinal end 28 of the rail 24 may vary slightly. Sections are often cut to fit in the field to varying lengths.

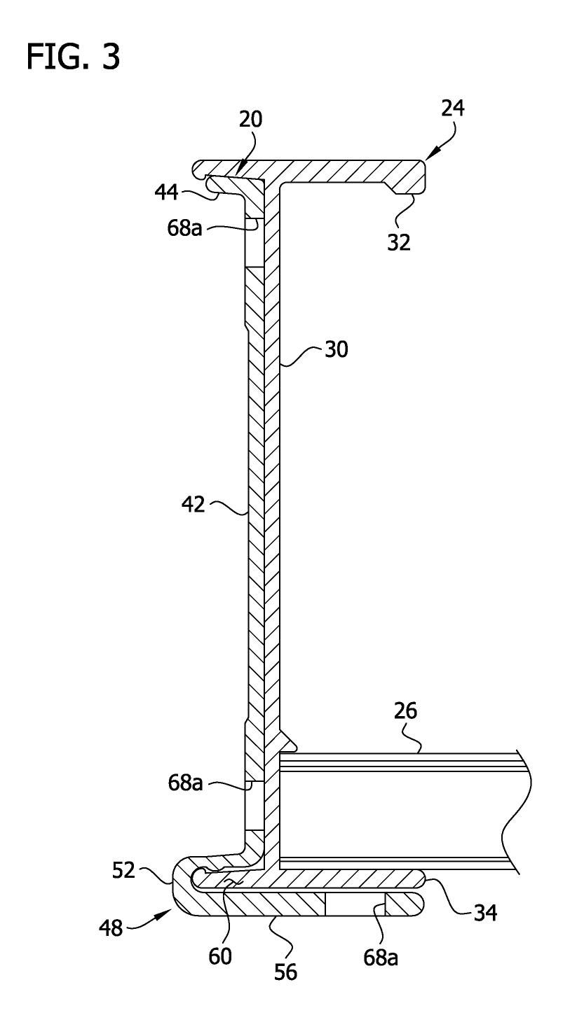

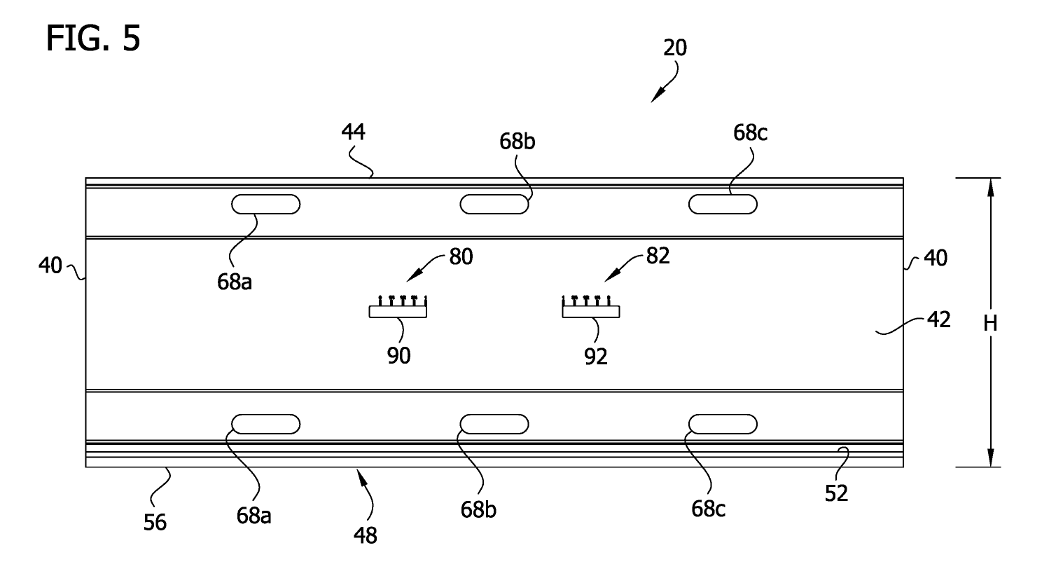

Referring to FIGS. 3 and 5, each expansion splice plate 20 has opposite first and second longitudinal ends 40 and a length extending between the longitudinal ends. The splice plate 20 includes a plate body 42 having a generally rectangular and planar shape lying in a generally vertical plane, an upper generally horizontal flange 44 extending laterally outward (i.e., in an outboard direction) from an upper end of the web, and a lower flange portion, such as a bottom channel portion 48, at a lower end of the web. The plate body 42 has inboard and outboard faces, and opposite first and second longitudinal ends coextensive with the first and second longitudinal ends of the splice plate 20 in the illustrated embodiment. The bottom channel section 48 has a heel portion 52 projecting laterally outward (i.e., in an outboard direction) from the plate body 42 and a generally horizontal toe portion 56 projecting laterally inward (i.e., in an inboard direction) from the heel portion to a location inboard of the plate body 42. The heel and toe portions 52, 56 define a channel 60 for receiving outboard portions of the lower flanges 34 of the rails 24 of the two cable tray sections 10A, 10B. The splice plate 20 may be of other types and configurations. For example, the splice plate may include a plate body but not one or both of the upper and lower flanges 44, 48.

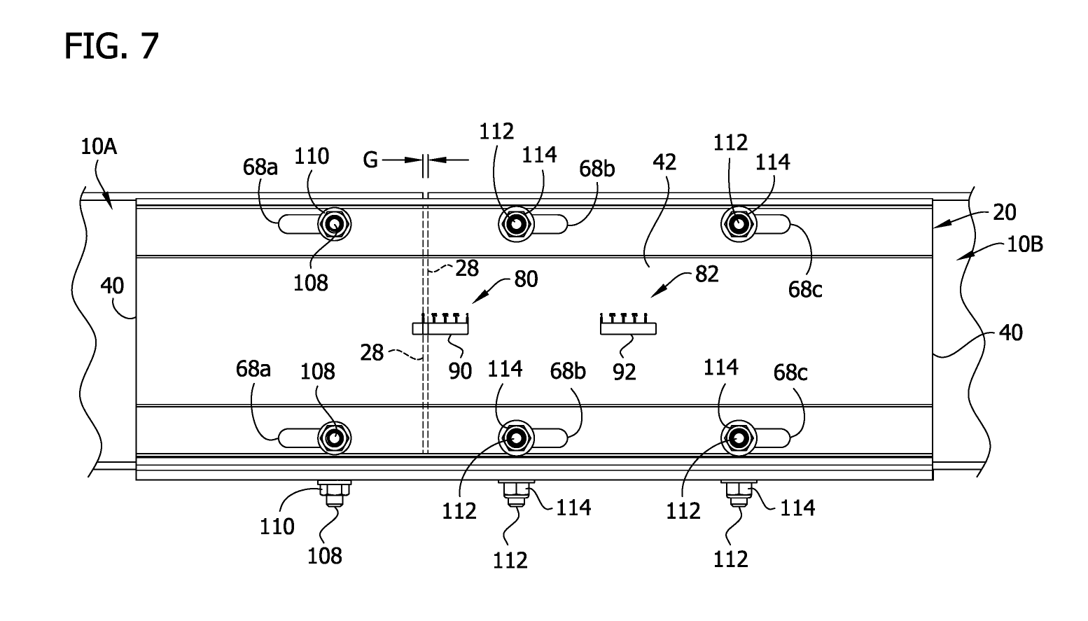

The splice plates 20 are sized and dimensioned to have a relatively close fit with the cable tray sections 10A, 10B to be connected by the plates. In the illustrated embodiment, shown in FIGS. 3 and 7, each splice plate 20 is sized and dimensioned to be placed in a splicing position in which it is nested between the upper and lower flanges 32, 34 of the two cable tray sections 10A, 10B. In this position, the upper flange 44 of the splice plate 20 extends generally parallel to and immediately below (desirably abutting) the upper flange 32 of the two cable tray sections 10A, 10B; the plate body 42 of the splice plate 20 extends generally parallel to and immediately adjacent (desirably abutting) the vertical webs 30 of the cable tray sections on the outboard side of the rails 24; and the outboard portions of the lower flanges 34 of the cable tray sections are received in the channel 60 formed by the bottom channel 48 of the splice plate such that the toe portion 56 underlies (desirably abutting) the lower flanges 34 of the cable tray sections. The fit is such that the upper flange 44, the plate body 42, and lower flange 48 of each splice plate 20 are in contact (or near contact) with respective surfaces of the cable tray sections 10A, 10B.

Referring to FIG. 5, the splice plate 20 includes at least two fastener openings spaced apart along the length of the splice plate and configured to receive fasteners to secure the splice plate to adjacent cable tray sections 10A, 10B. In the illustrated embodiment, the splice plate includes three sets of fastener openings 68a, 68b, 68c for receiving fasteners to secure the splice plate to adjacent cable tray sections 10A, 10B. The sets of fastener openings 68a, 68b, 68c are spaced apart along the length of the splice plate 20. Each set of fastener openings 68a, 68b, 68c includes three elongate, generally vertically-aligned slot-shaped openings, two of which are in the plate body 42 and one of which is in the toe portion 56 of the bottom channel section 48. The slot-shaped openings 68a, 68b, 68c have major axes extending along the length of the splice plate 20 to allow for relative movement between the cable tray sections 10A, 10B. The slot-shaped fastener openings 68a, 68b, 68c may have substantially the same length (e.g., 1.5 in.). The three fastener openings 68a, 68b, 68c in each respective set have centers that are substantially aligned along the height H of the splice plate 20, i.e., the three slot openings of each set lie in a single plane extending transverse to the splice plate through the slot centers. When the splice plate 20 is in its splicing position, the fastener openings 68a, 68b are positioned to align with the pre-drilled fastener holes 36 in the webs 30 and lower flanges 34 of adjacent rails 24 of the two cable tray sections 10A, 10B to be spliced together. It is understood that the number and arrangement of fastener openings 68a, 68b, 68c in the splice plates 20 and aligned fastener holes in the cable tray sections may vary without departing from the scope of the present invention. The slot openings 68a, 68b, 68c may have other configurations and may be arranged on the splice plate in other ways without departing from the scope of the invention.

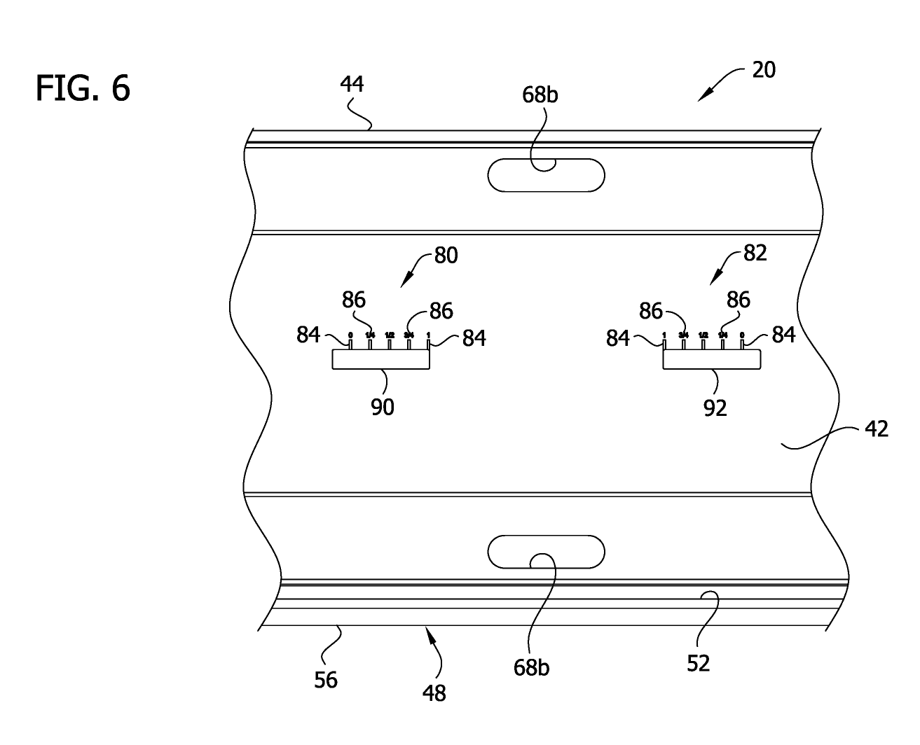

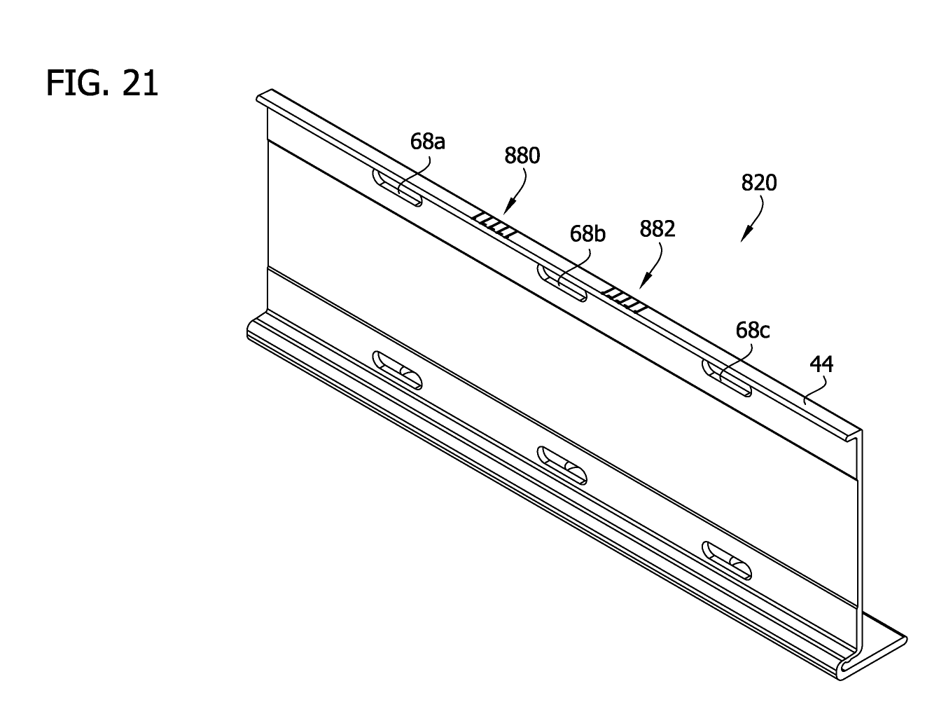

Referring to FIGS. 5 and 6, the splice plate 20 includes spacing indicia configured to indicate to the user the longitudinal spacing between the longitudinal ends 28 of the spliced cable tray sections 10A, 10B. The illustrated spacing indicia includes at least one set of spacing indicia, and in particular, first and second sets of spacing indicia, generally indicated at 80, 82, respectively. In the illustrated embodiment, each set of spacing indicia 80, 82 is disposed on the plate body 42 of the splice plate 20, and more particularly, on the outboard side of the plate body. In other embodiments, such as shown in FIGS. 21-24 and described below, each set of spacing indicia may also or alternatively be disposed on one or more of the upper flange portion 44 or the lower flange portion (e.g., bottom channel portion 48) or other portions or structures of the splice plate 20. Each set of spacing indicia 80, 82 includes markings 84 that may be generally alignable and/or associated with the adjacent longitudinal ends 28 of the cable tray sections 10A, 10B to indicate the longitudinal spacing G between the cable tray sections when the splice plate 20 is in place on (e.g., secured to) the cable tray sections. The markings 84 may any one or combination of suitable types, including cutouts, openings, indentations, nubs, dimples, etchings, embossments, adhesives, prints, inks, stampings, etc.

At least a portion of each spacing indicia 80, 82 (and the other embodiments of the spacing indicia described below) is disposed longitudinally between adjacent sets of the fastener openings 68a, 68b, 68c. In the illustrated embodiment, the first set of spacing indicia 80 is disposed longitudinally between the first and second sets of openings 68a, 68b. In the illustrated embodiment, the second set of spacing indicia 82 is disposed longitudinally between the second and third sets of openings 68b, 68c. In the illustrated embodiment, the entirety of each set of spacing indicia 80, 82 is disposed longitudinally between adjacent sets of the openings 68a, 68b, 68c.

Referring to FIG. 6, the illustrated markings 84 are calibrated markings (e.g., calibrated lines, such as vertical lines) spaced apart longitudinally on the splice plate 20. For example, the calibrated markings 84 may be spaced apart at predetermined uniform intervals of length, such as 0.25 in (6.35 mm) intervals. In one example, the calibrated lines 84 or other calibrated markings are marked or associated with the unit of length marking 86, much like a ruler. Accordingly, each set spacing indicia 80, 82 on the splice plate 20 may be used like a ruler, whereby the desired longitudinal spacing G between the cable tray sections 10A, 10B may be accomplished by aligning structures (e.g., the adjacent longitudinal edges 28) of the cable tray sections with selected calibrated markings 84 and associated unit of length markings 86 indicating the desired longitudinal spacing.

The calibrated markings 84 of each set of spacing indicia 80, 82 include a “zero” or reference marking (marked with “0” length marking 86 in drawings) to which a reference structure (e.g., the longitudinal end 28) of a reference cable tray section 10A, 10B is alignable when the splice plate 20 is placed thereon (e.g. secured thereto). Accordingly, the reference marking 84 is spaced a suitable longitudinal distance from the set of fastener openings 68a, 68c in the plate body 42, for example, so that the longitudinal end 28 of the reference cable tray section 10A, 10B can be aligned with the reference marking.

In the illustrated embodiment, the splice plate 20 includes the two sets of spacing indicia 80, 82 so that either one of the cable tray sections 10A, 10B can be used as the reference cable tray section, where, for example, the reference cable tray section is a fixed cable tray section and the other cable tray section is the expanding cable tray section, as explained in more detail below. As an example, the first set of spacing indicia 80 may be used when the first cable tray section 10A is used as the reference cable tray section, and the second set of spacing indicia 82 may be used when the second cable tray section 10B is used as the reference cable tray section. Where the first cable tray section 10A is used as the reference cable tray section, the longitudinal end 28 of the first cable tray section is aligned with the reference marking 84 of the first set of spacing indicia 80, and the longitudinal position of the second cable tray section 10B to the right of the first cable tray section can be adjusted relative to the splice plate 20 and the first cable tray section so that the adjacent longitudinal end 28 of the second cable tray section can be aligned with the calibrated marking 84 and associated unit of length marking 86 of the first set of spacing indicia 82 indicating the desired longitudinal spacing G between the cable tray sections. Thus, the unit of length markings 86 of the first set of spacing indicia 80 increase to the right of the reference marking. Where the second cable tray section 10B is used as the reference cable tray section, the longitudinal end of the second cable tray section is aligned with the reference marking of the second set of spacing indicia 82, and the longitudinal position of the first cable tray section 10A to the left of the second cable tray section can be adjusted relative to the splice plate 20 and the second cable tray section so that the adjacent longitudinal end 28 of the first cable tray section is aligned with the calibrated marking 84 and associated unit of length marking 86 of the second set of spacing indicia 82 indicating the desired longitudinal spacing G between the cable tray sections. Thus, the unit of length markings 86 of the second set of spacing indicia 82 increase to the left of the reference marking.

Referring to FIGS. 5 and 6, in the illustrated embodiment, the splice plate 20 further includes at least one window (e.g., first and second windows 90, 92) adjacent respective sets of spacing indicia 80, 82. Each window 90, 92 allows the user to view at least one of the cable tray sections 10A, 10B therethrough (e.g., the longitudinal end 28 of at least one of the cable tray sections) to facilitate alignment of the desired markings 84, 86 of the spacing indicia 80, 82 with the structures (e.g., the longitudinal edges) of the cable tray sections. Each of the illustrated windows 90, 92 is a slot-shaped opening extending through the inboard and outboard sides of the plate body 42. At least a portion of each window 90, 92 (and the other embodiments of the window described below) is disposed longitudinally between adjacent sets of the openings 68a, 68b, 68c. In the illustrated embodiment, the first window 90 is disposed longitudinally between the first and second sets of openings 68a, 68b. In the illustrated embodiment, the second window 92 is disposed longitudinally between the second and third sets of openings 68b, 68c. In the illustrated embodiment, the entirety of each window 90, 92 is disposed longitudinally between adjacent sets of the openings 68a, 68b, 68c.

Referring to FIG. 6, the calibrated markings 84 (e.g., calibrated vertical lines) extend along the length of the corresponding window 90, 92 at spaced apart intervals. The illustrated “zero” or reference marking 84 is spaced apart a distance from an adjacent longitudinal end of the window 90, 92 to allow for some tolerance between cable tray sections 10A, 10B having different distances between the fastener openings 36 and the corresponding longitudinal ends 28. As a non-limiting example, the reference marking 84 may be spaced 0.25 in (6.35 mm) from the adjacent longitudinal end of the window 90, 92. In other embodiments, the reference marking 84 may be at the longitudinal end of the window 90, 92.

Referring to FIGS. 2 and 7-9, in one embodiment of a method of splicing the two cable tray sections 10A, 10B to one another, bolts 108 are inserted through the first set of openings 68a of the splice plates 20 and through the aligned pre-drilled fastener holes 36 in the web 30 and lower flange 34 of the rails 24 of the left cable tray section 10A. Similarly, bolts 112 are inserted through the openings 68b, 68c of the splice plate 20 and through aligned fastener holes 36 in the web 30 and lower flange 34 of the rail 24 of the right cable tray section. (Only one splice plate 20 at one side of the cable tray sections is shown in FIGS. 7-9; a second identical splice plate is on the opposite side of the cable tray sections.) In one example, the splice plate(s) 20 are fastened to the first cable tray section 10A using nuts 110 threaded on the bolts 108 before inserting the bolts 112 through the slot openings 70 of sets 60b and 60c of the splice plate. Before tightening the nuts 110 on the bolts 108, the longitudinal end of the first cable tray section is aligned with the reference marking (e.g., “zero” marking) of the first set of spacing indicia. After alignment, the nuts 110 may be tightened to securely fasten the splice plates to the first cable tray section 10A. By way of example but not limitation, the nuts 110 may be tightened to a torque of 50 ft/lb. In the preferred embodiment, these tightened nuts 110 do not move in their respective openings 68a. Nuts 114 (e.g., elastic stop nuts) may be loosely threaded on the bolts 112 to retain the splice plate 20 on the second cable tray section 10B.

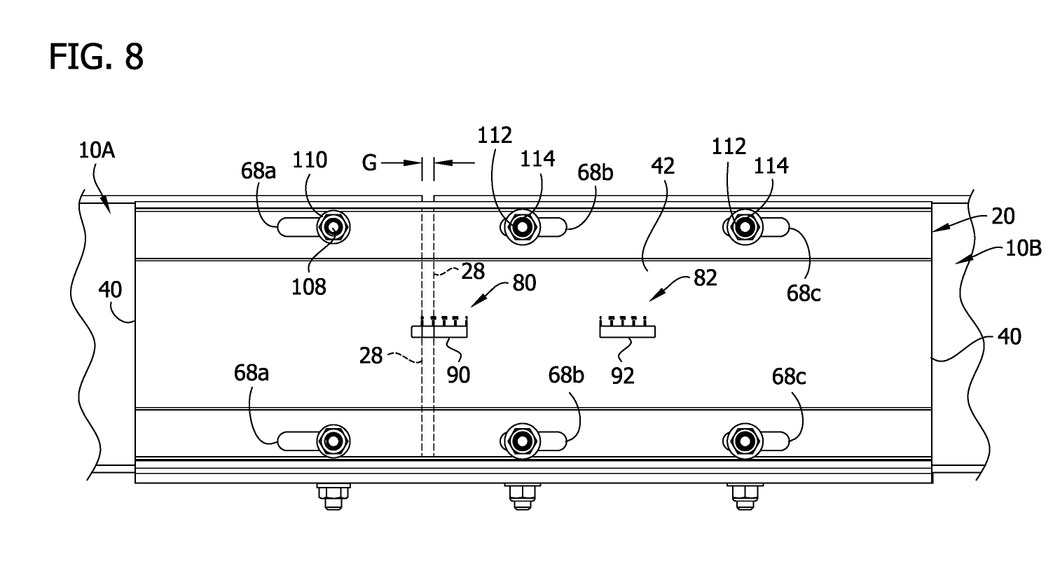

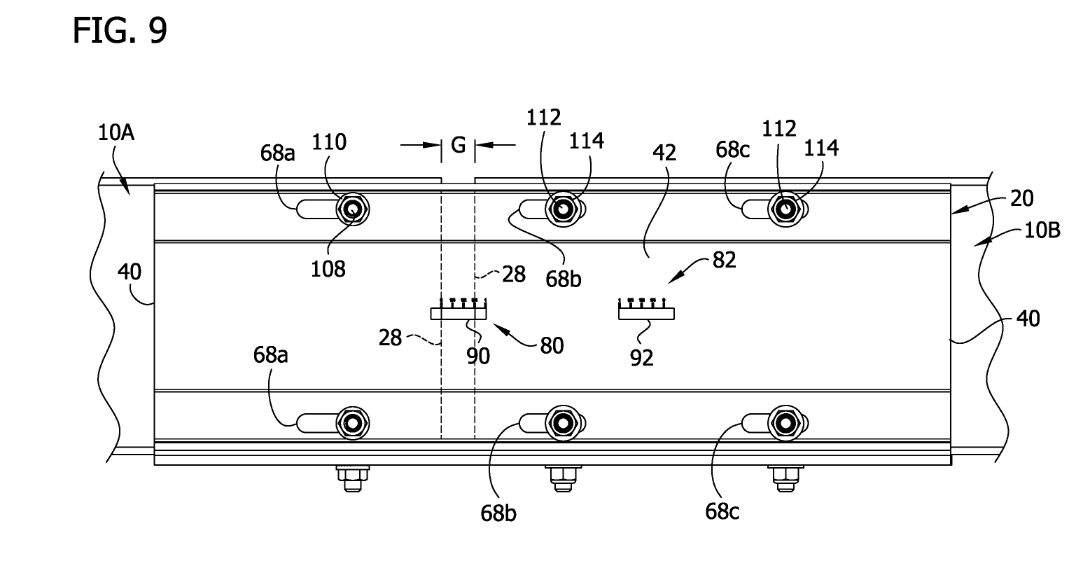

As shown in FIGS. 8 and 9, with the splice plate(s) 20 securely fastened to the first cable tray section 10A, the longitudinal spacing G between the two cable tray sections 10A, 10B is adjusted by longitudinally moving (e.g., sliding) the second cable tray section 10B relative to the splice plate and the first cable tray section such that the longitudinal end 28 of the second cable tray section aligns with the calibrated marking 84 of the first set of spacing indicia 80 that indicates the desired longitudinal spacing. This desired longitudinal spacing may be based on certain temperature parameters (e.g., highest expected metal temperature, lowest expected metal temperature, and metal temperature at time of installation), as will be understood by those skilled in the art. In FIG. 8, the spacing G between the first and second cable tray sections 10A, 10B is 0.25 in (6.35 mm). In FIG. 9, the spacing G between the first and second cable tray sections 10A, 10B is 1.0 in (2.54 cm). After the longitudinal spacing G is set, the nuts 114 are tightened on the fasteners 104 until snug and then backed off a small amount (e.g., one-quarter turn) to permit relative movement of the bolts 112 in the slots of sets 68b and 68c, such as during thermal expansion and contraction of the sections.

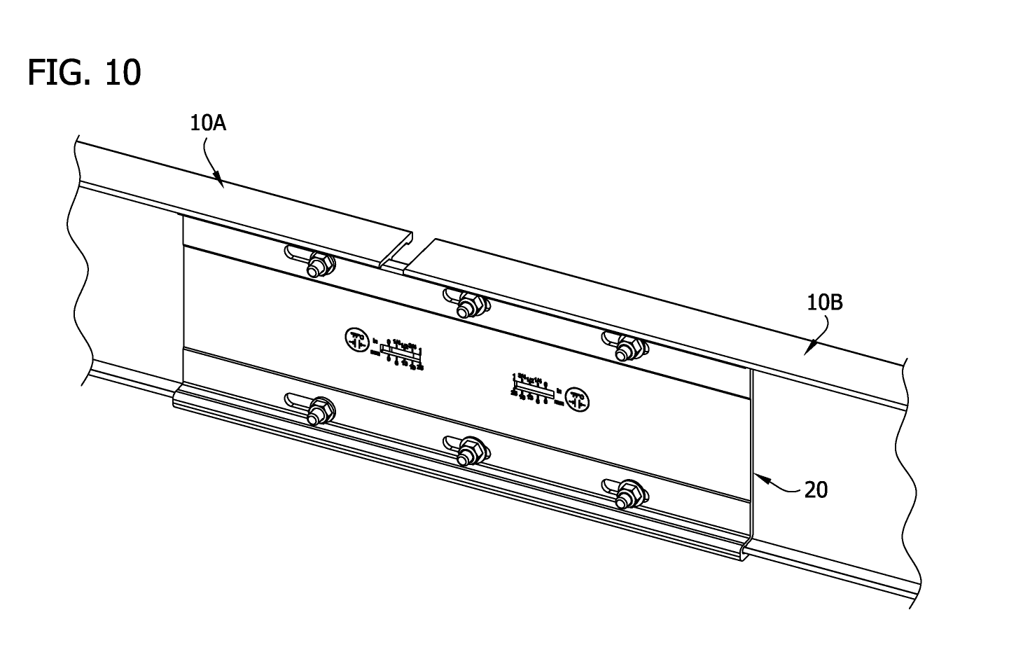

It is understood that the second set of spacing indicia 82 may be used in a similar way where the second cable tray section 10B is used as the reference cable tray section, as shown in FIG. 10, for example. In this example, expansion occurs on the first cable tray section 10A (i.e., the left cable tray section).

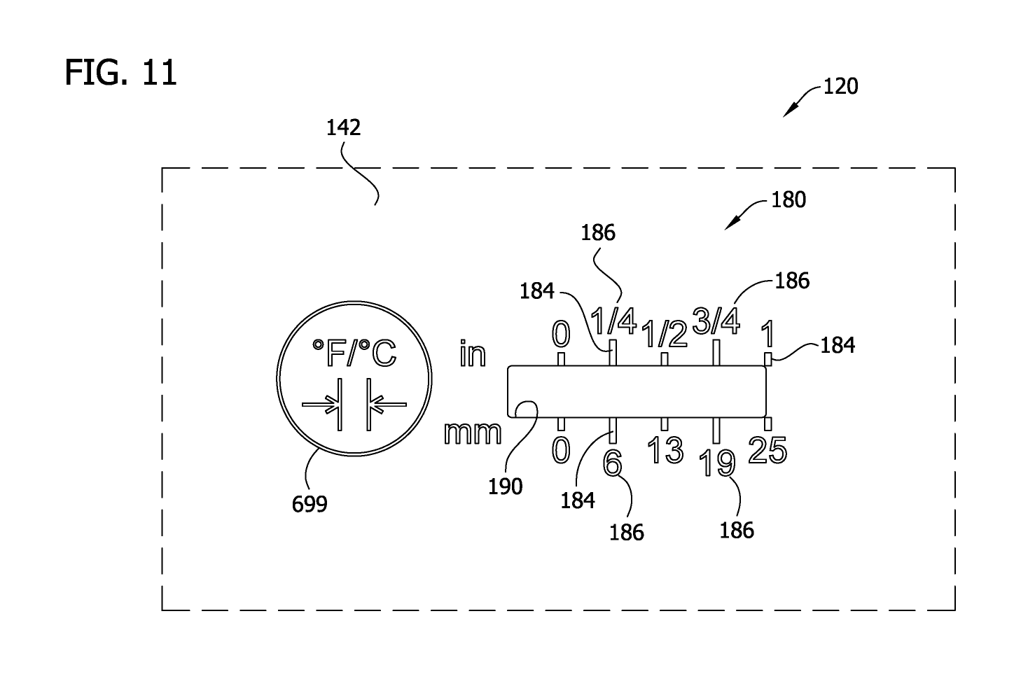

Referring to FIG. 11, a set of spacing indicia 180 and an associated window 190 on a plate body 142 for another embodiment of a splice plate 120 are similar to the first set of indicia 80 and the first window 90 shown in FIGS. 5 and 6. The differences being the arrangement of calibrated markings 184 and unit of length markings 186, which include two different measuring systems (e.g., metric system and English system). It is understood that a second set of indicia and a second associated window may be similar constructed on the splice plate based on the teachings set forth above.

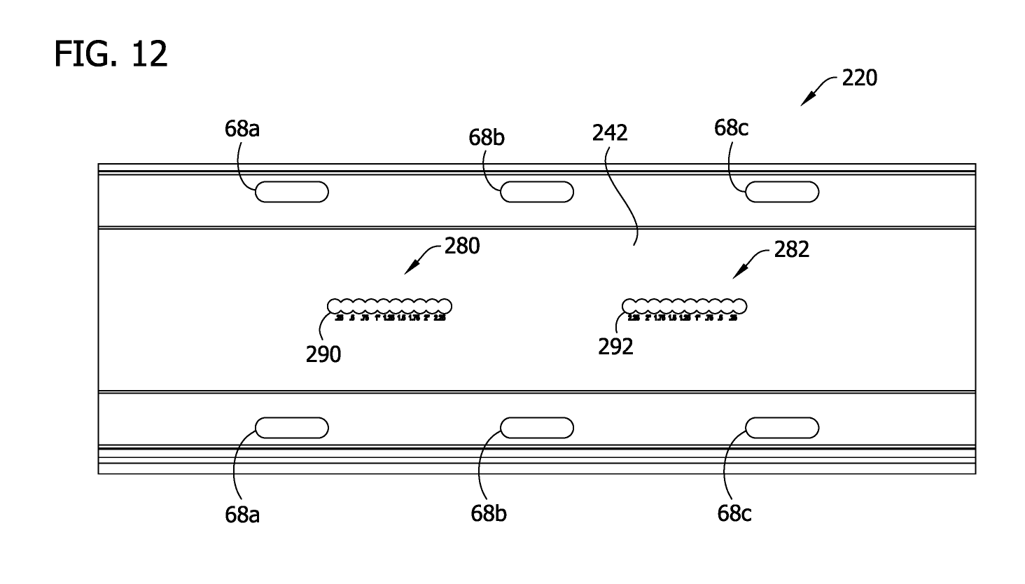

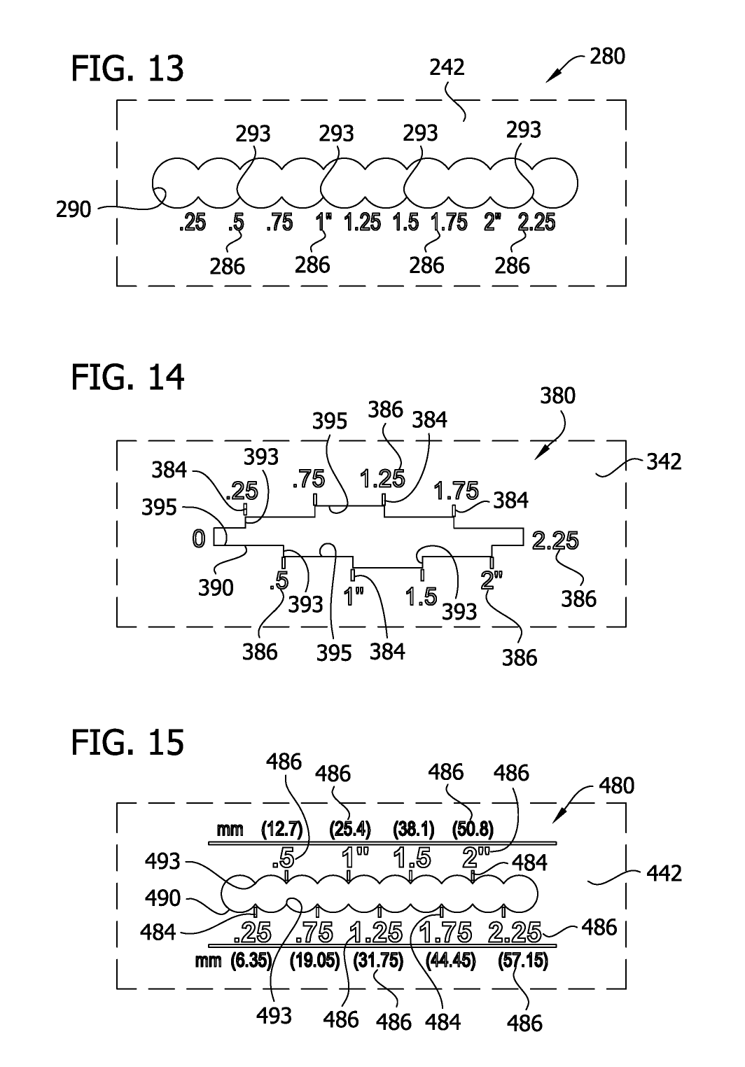

Referring now to FIGS. 12 and 13, another embodiment of a splice plate is generally indicated at reference numeral 220. This splice plate 220 is identical to the splice plate 20 other than it includes an alternative embodiment of sets of spacing indicia (e.g., at least one spacing indicia), generally indicated at reference numeral 280, 292, and alternative embodiments of windows 290, 292 associated with respective ones of the sets of spacing indicia, each of which is constructed according to the teachings of the present disclosure. Components of the splice plate 220 that are the same as the components of the first splice plate 20 may be indicated by corresponding reference numerals.

Each window 290, 292 is formed by a series of overlapping circular openings in the plate body 242 of the splice plate 220. The junctions of adjacent overlapping circular openings define peaks 293 that are spaced longitudinally apart from one another at predetermined intervals of distance, such as 0.25 in (6.35 mm) as illustrated. These peaks 293 can be considered calibrated markings. The set of spacing indicia 280, 282 associated with each window 290, 292 includes unit of length markings 286 based on the spacing intervals of the peaks 293. Thus, as can be understood, the peaks 293 are used similar to the line markings 84 in the first embodiment 20. Thus, using the present splice plate 220, the longitudinal end 28 (or other structure) of the reference cable tray section (e.g., cable tray section 10A) is aligned with a reference longitudinal end of the window 290 (i.e., the longitudinal end adjacent the lowest unit of length marking), and the longitudinal end of the expandable cable tray section (e.g., cable tray section 10B) is aligned with the peak 293 associated with the unit of length marking 286 that matches the desired longitudinal spacing G of the cable tray sections. As with the first embodiment, the first set of spacing indicia 280 and the first window 290 are used when the first cable tray section 10A is the reference cable tray and the second cable tray section 10B is the expanding cable tray section; and the second set of spacing indicia 282 and the second window 292 are used when the second cable tray section 10B is the reference cable tray and the first cable tray section 10A is the expanding cable tray section. The method of using the splice plate 220 is similar to the method disclosed above with respect to the first splice plate 20, therefore, the teachings set forth above apply equally to the present splice plate.

FIG. 14 shows an enlarged, partial view of a plate body 342 of another embodiment of a splice plate including an alternative embodiment of a set of spacing indicia (e.g., at least one spacing indicia), generally indicated at reference numeral 380, and an alternative embodiment of a window 390 associated with the set of spacing indicia. The window 390 has stepped upper and lower edges having riser portions 393 and intersecting step portions 395. The risers 393 are spaced longitudinally apart from one another at predetermined intervals, such as 0.25 in (6.35 mm) as illustrated. The set of spacing indicia 380 associated with each window 390 includes calibrated markings 384 associated with the risers 393, and unit of length markings 386 associated with the respective calibrated markings and risers. Thus, as can be understood, the risers 393 and the calibrated markings 384 are used similar to the line markings 84 in the first embodiment 20.

Using the splice plate including the present set of spacing indicia 380, the longitudinal end (or other structure) of the reference cable tray section (e.g., cable tray section 10A) is aligned with the reference longitudinal end of the window (i.e., the longitudinal end marked “0”) and the longitudinal end of the expandable cable tray section (e.g., cable tray section 10B) is aligned with the riser 393 and the calibrated line marking 384 associated with the unit of length marking 386 that matches the desired longitudinal spacing G of the cable tray sections. As with the first embodiment, the first set of spacing indicia 380 and the first window 392 are used when the first cable tray section 10A is the reference cable tray section and the second cable tray section 10B is the expanding cable tray section. It is understood that the splice plate may include a second set of spacing indicia and a second window associated with the second set of spacing indicia, similar in use and function as the second set of spacing indicia of the first splice plate. The second set of spacing indicia and the second window are used when the second cable tray section is the reference cable tray section and the first cable tray section is the expanding cable tray section. The method of using the splice plate is similar to the method disclosed above with respect to the first splice plate 20, therefore, the teachings set forth above apply equally to the splice plate including the set of indicia 380 and the window 390.

Referring to FIG. 15, a set of spacing indicia 480 and an associated window 490 on a plate body 442 for another embodiment of a splice plate are similar to the set of indicia 280 and the window 290, which define peaks 493, shown in FIGS. 12 and 13. The differences being the arrangement of calibrated markings 484 and unit of length markings 486, which include two different measuring systems (e.g., metric system and English system). It is understood that a second set of indicia and a second associated window may be similar constructed on the splice plate based on the teachings set forth above.

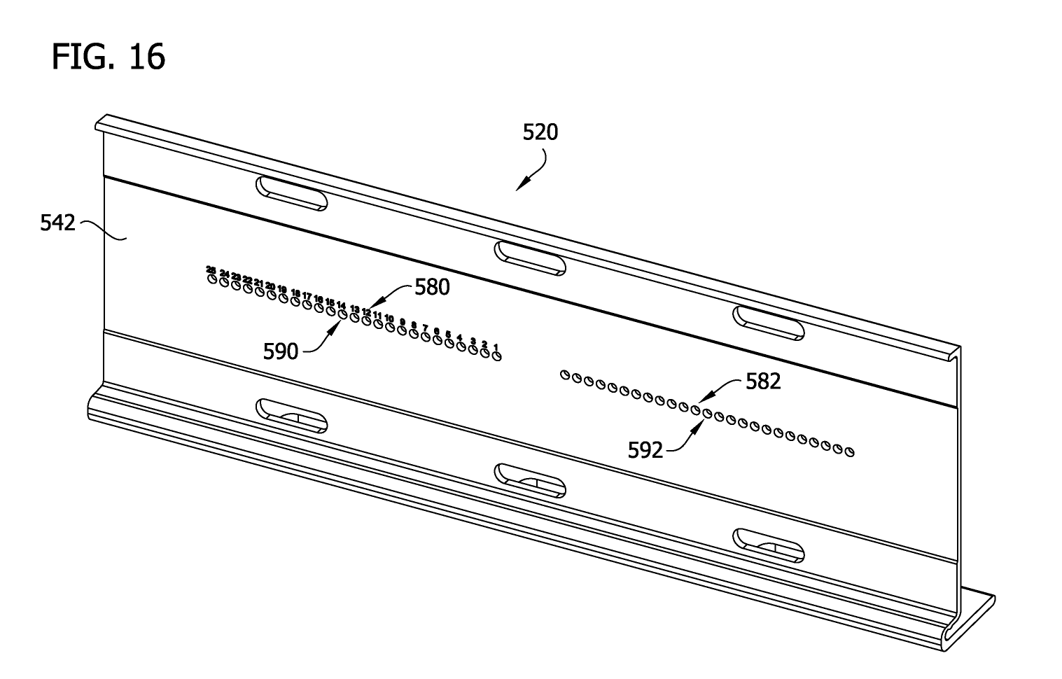

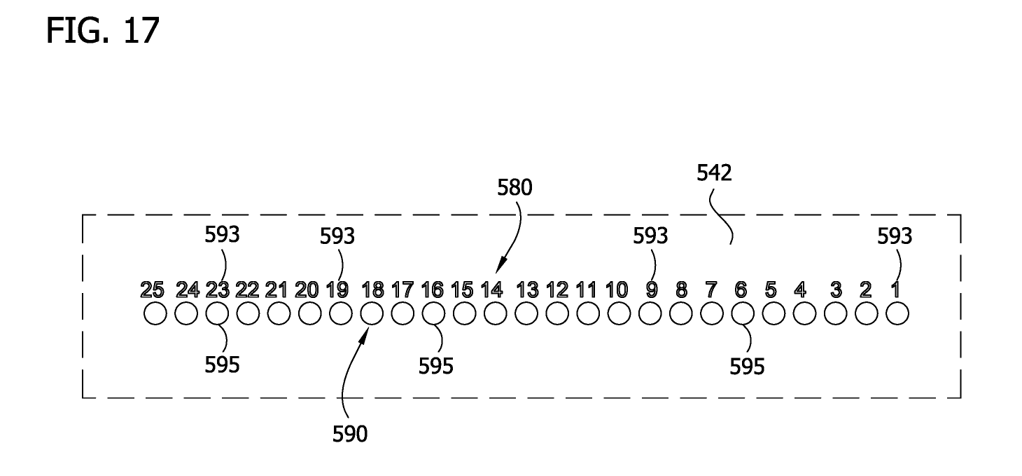

Referring now to FIGS. 16 and 17, another embodiment of a splice plate is generally indicated at reference numeral 520. This splice plate 520 is identical to the splice plate 20 other than it includes an alternative embodiment of sets of spacing indicia (e.g., at least one spacing indicia), generally indicated at reference numeral 580, 582, and alternative embodiments of windows 590, 592 associated with respective ones of the sets of spacing indicia, each of which is constructed according to the teachings of the present disclosure. Components of the splice plate 520 that are the same as the components of the first splice plate may be indicated by corresponding reference numerals.

In this embodiment, each set of spacing indicia 580, 582 includes spaced apart numerical markings 593 (e.g., markings “1” through “25”). Moreover, each window, generally indicated at 590, 592, comprises a set of spaced apart openings 595 extending through the plate body 542. Each numerical marking 593 is associated with one of the spaced apart openings 595, such as by being placed adjacent the associated opening. Each numerical marking 595 may be indicative of a longitudinal spacing between the first and second cable tray sections 10A, 10B when aligned with respective ones of the numerical markings. Thus, the sets of indicia 580, 582 and the windows 590, 592 may be used in a similar manner as the embodiments disclosed above to space the first and second tray sections 10A, 10B apart from one another a desired longitudinal distance G.

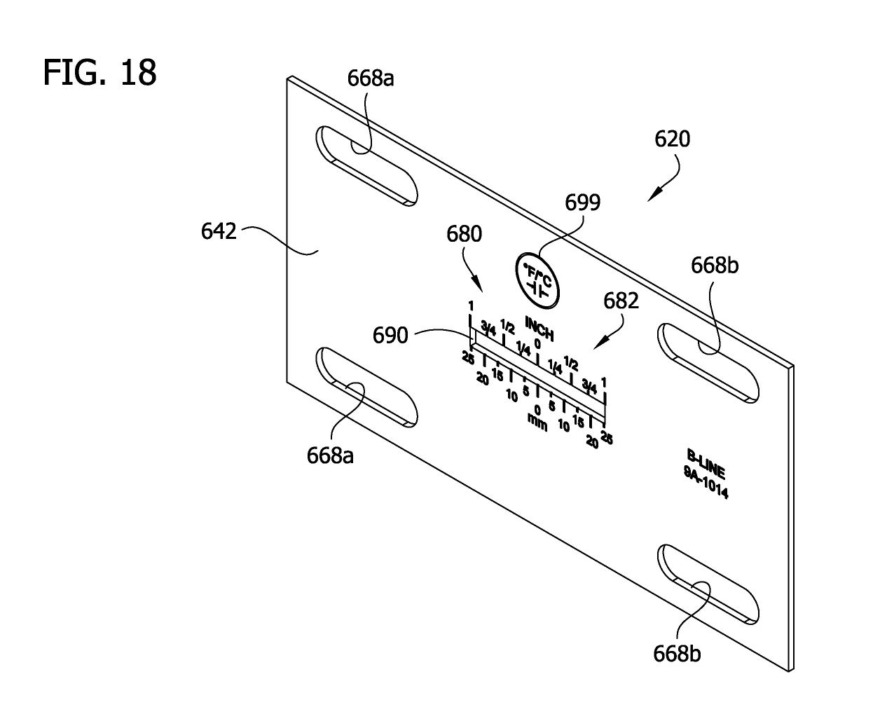

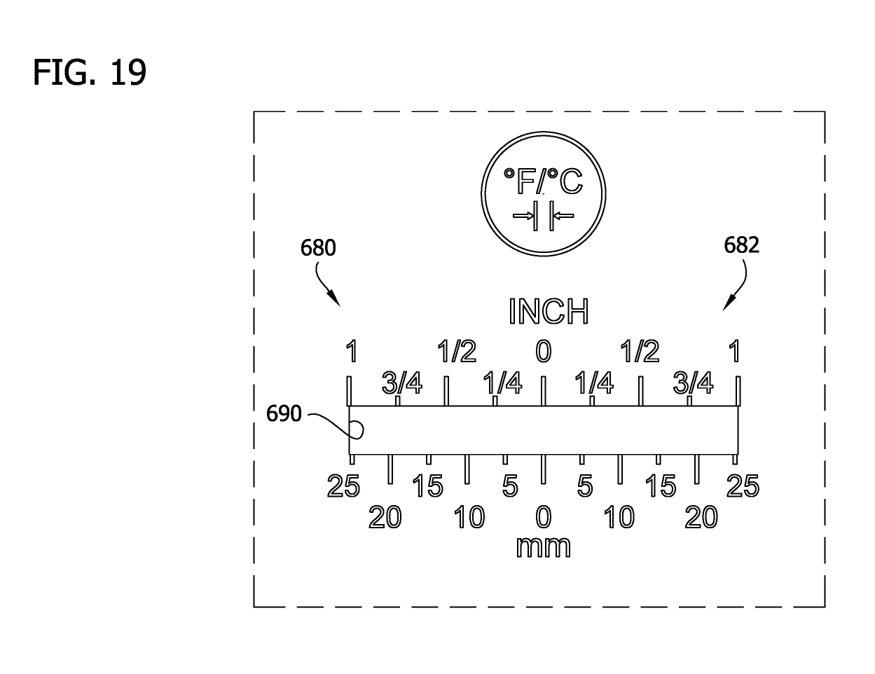

As described above, the set(s) of indicia and/or the window(s) may be incorporated in other types of splice plates having designs and configurations different from the splice plates described above. An example of another splice plate is generally indicated at reference numeral 620 in FIGS. 18 and 19. This splice plate 620 includes a plate body 642 having a generally rectangular and planar shape. Unlike the splice plates described above, the splice plate 620 does not include upper and lower flanges. Moreover, the splice plate 620 includes first and second sets of openings 668a, 668b (e.g., upper and lower openings) spaced apart longitudinally along the plate body 642. Each opening 668a, 668b has a slot shape, although the openings may have other shapes.

In this embodiment, at least one set of spacing indicia (e.g., first and second sets of spacing indicia 680, 682) is disposed longitudinally between the first and second sets of openings 668a, 668b. At least one window (e.g., a single window 690) is associated with the sets of spacing indicia 680, 682, similar to the teachings set forth above with respect to embodiment shown in FIGS. 5 and 6. The sets of indicia 680, 682 and/or the window 690 may be used in the same way as explained above with respect to the embodiment shown in FIGS. 5 and 6, and therefore, the corresponding teachings set forth with respect to FIGS. 5 and 6 apply equally to this embodiment.

In one or more embodiments, such as the embodiments shown in FIGS. 11 and 18, the splice plate 120, 620 includes a notification marking 699 (e.g., a label, an adhesive label, an embossing, an engraving, a stamping, an etching, etc.) indicating to the user that the cable tray sections 10A, 10B need to be spaced apart longitudinally using the splice plate, and that the set of spacing indicia 180, 680, 682 and/or the window 190, 690 are used to set the proper longitudinal distance G between the first and second cable tray sections 10A, 10B.

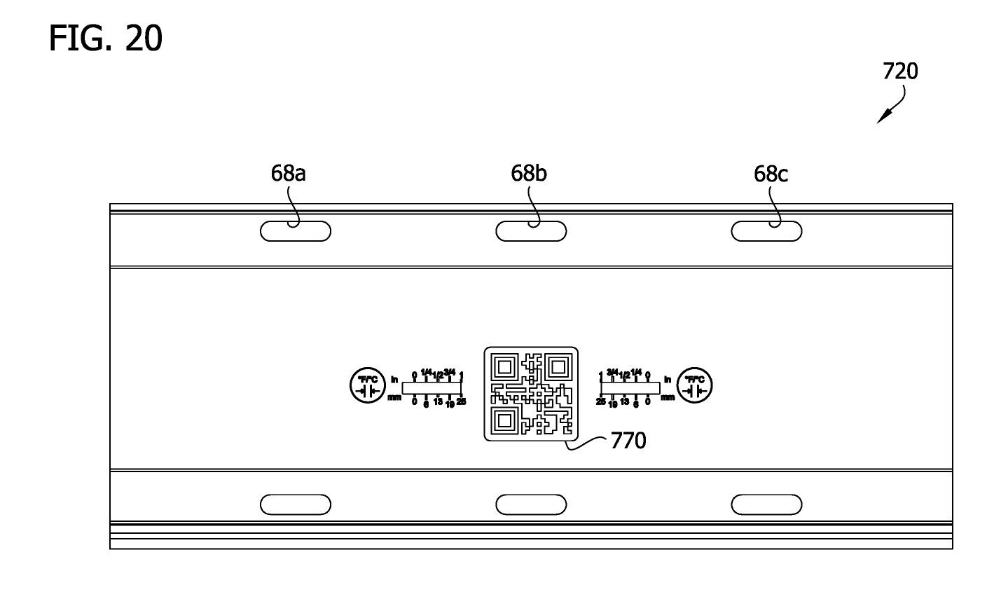

In one or more embodiments, such as the embodiment shown in FIG. 20, a splice plate, generally indicated at reference numeral 720, includes a machine readable marking 770 (e.g., a label, an adhesive label, an embossing, an engraving, a stamping, an etching, etc.). In this embodiment, other than the machine readable marking 770, the splice plate 720 is identical to the second splice plate 120, with some of the identical components indicated by corresponding reference numeral. It is understood that the machine readable marking 770 may be part of other splice plates. The machine readable marking 770 may comprise a machine readable optical code, such as a matrix or two-dimensional barcode as illustrated. In another example, the machine readable marking may comprise a wireless communication device, such as a near-field communication (NFC) tag or chip or a radio-frequency identification tag or chip.

This machine readable marking 770 may include machine-readable representation of a web address that is readable by and/or wirelessly communicated to a computer processor. The webpage or website at the web address may contain information relating to instructions for installing the splice plate 720 on the cable tray sections 10A, 10B including information for the proper spacing of the cable tray sections based on its application. In one example, a user may scan or wirelessly communicated with the machine readable marking 770 using a hand-held device including processor and memory that is connectable (e.g., wirelessly connectable) to the Internet. Scanning or wirelessly communicating with the machine readable marking 770 may direct the hand-held device to a webpage at the web address represented by the machine readable marking that includes the instructions for properly spacing the cable tray sections 10A, 10B and/or other information relating to the splice plate 720 and its use. This information may be displayed on a display of the hand-held device for the user in the field.

Referring to FIGS. 21-24, another embodiment of a splice plate is generally indicated at reference numeral 820. This splice plate 820 is identical to the splice plate 20 other than it includes an alternative embodiment of sets of spacing indicia (e.g., at least one spacing indicia), generally indicated at reference numeral 880, 882, and does not include windows, for reasons which will be apparent hereinafter. Components of the splice plate 820 that are the same as the components of the first splice plate 20 may be indicated by corresponding reference numerals.

In the illustrated embodiment, each set of spacing indicia 880, 882 is disposed on the upper flange 44 of the splice plate 820, and more particularly, on the upper surface of the upper flange. Each set of spacing indicia 880, 882 includes markings 884 that may be generally alignable and/or associated with the adjacent longitudinal ends 28 of the cable tray sections 10A, 10B to indicate the longitudinal spacing G between the cable tray sections when the splice plate 820 is in place on (e.g., secured to) the cable tray sections. As with the prior embodiments, the markings 884 may any one or combination of suitable types, including cutouts, openings, indentations, nubs, dimples, etchings, embossments, adhesives, prints, inks, etc.

At least a portion of each spacing indicia 880, 882 (and the other embodiments of the spacing indicia described below) is disposed longitudinally between adjacent sets of the fastener openings 68a, 68b, 68c. In the illustrated embodiment, the first set of spacing indicia 880 is disposed longitudinally between the first and second sets of openings 68a, 68b. In the illustrated embodiment, the second set of spacing indicia 882 is disposed longitudinally between the second and third sets of openings 68b, 68c. In the illustrated embodiment, the entirety of each set of spacing indicia 80, 82 is disposed longitudinally between adjacent sets of the openings 68a, 68b, 68c.

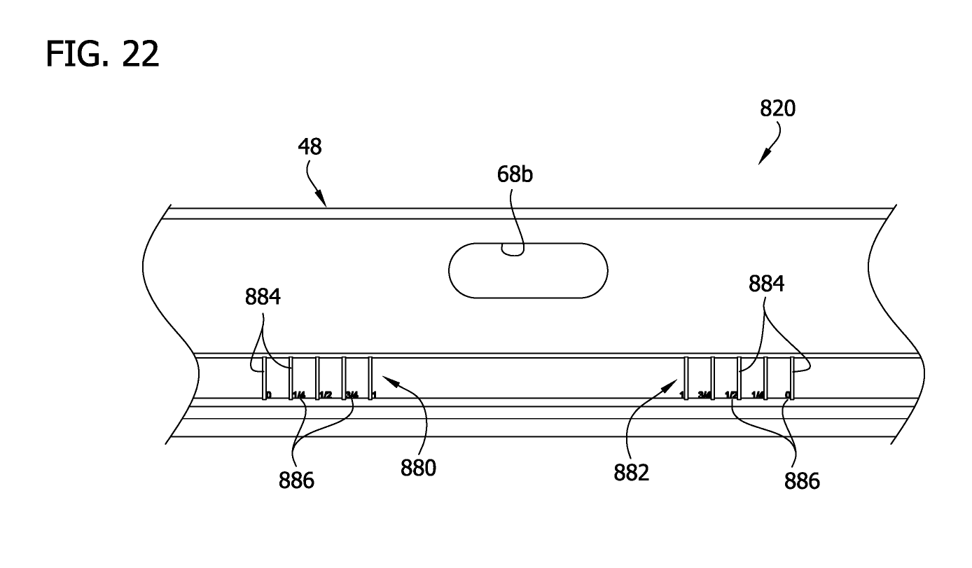

Referring to FIG. 22, the illustrated markings 884 are calibrated markings (e.g., calibrated lines, such as horizontal lines) spaced apart longitudinally on the splice plate 20. For example, the calibrated markings 884 may be spaced apart at predetermined uniform intervals of length, such as 0.25 in (6.35 mm) intervals. In one example, the calibrated lines 884 or other calibrated markings are marked or associated with the unit of length marking 886, much like a ruler. Accordingly, each set spacing indicia 880, 882 on the splice plate 820 may be used like a ruler, whereby the desired longitudinal spacing G between the cable tray sections 10A, 10B may be accomplished by aligning structures (e.g., the adjacent longitudinal edges 28) of the cable tray sections with selected calibrated markings 884 and associated unit of length markings 886 indicating the desired longitudinal spacing.

The calibrated markings 884 of each set of spacing indicia 880, 882 include a “zero” or reference marking (marked with a “0” unit of length marking 886 in drawings) to which a reference structure (e.g., the longitudinal end 28) of a reference cable tray section 10A, 10B is alignable when the splice plate 820 is placed thereon (e.g. secured thereto). Accordingly, the reference marking 884 is spaced a suitable longitudinal distance from the set of fastener openings 68a, 68c in the plate body, for example, so that the longitudinal end 28 of the reference cable tray section 10A, 10B can be aligned with the reference marking.

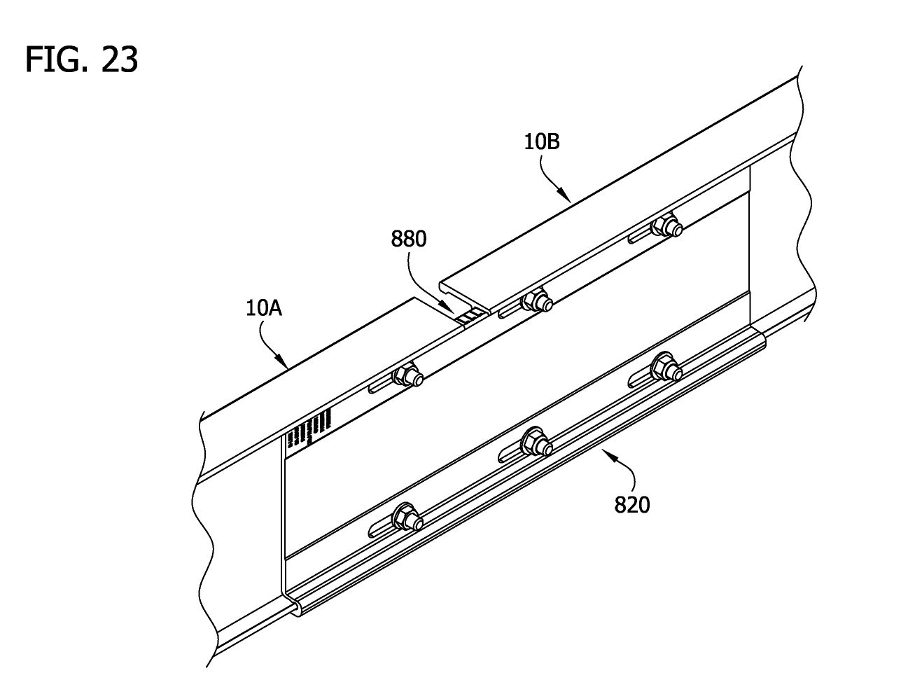

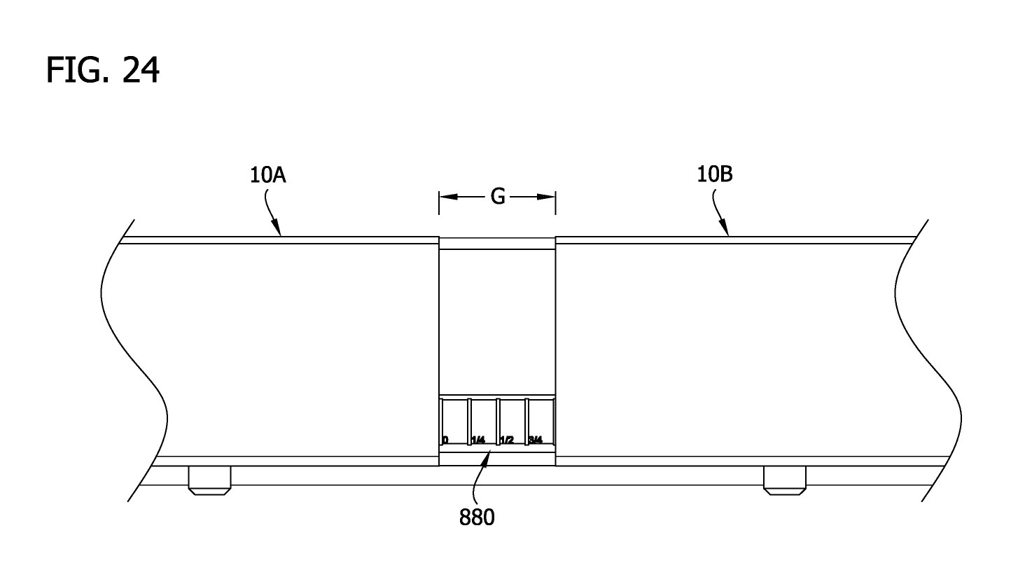

In the illustrated embodiment, the splice plate 820 includes the two sets of spacing indicia 880, 882 so that either one of the cable tray sections 10A, 10B can be used as the reference cable tray section, where, for example, the reference cable tray section is a fixed cable tray section and the other cable tray section is the expanding cable tray section, as explained in more detail below. As can be seen in FIGS. 23 and 24, the use of the splice plate 820 is similar to the use of the splice plate 20 described above, as can be understood.

Modifications and variations of the disclosed embodiments are possible without departing from the scope of the invention defined in the appended claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A splice plate for splicing together longitudinal ends of respective first and second cable tray sections to form a cable tray run, the splice plate having opposite first and second longitudinal ends and a length extending therebetween, the splice plate comprising:
a plate body having opposite inboard and outboard faces;
a first fastener opening extending through the inboard and outboard faces of the plate body, wherein the first fastener opening is configured to receive a first fastener to fasten the splice plate to the first cable tray section;
a second fastener opening extending through the inboard and outboard faces of the plate body, wherein the second opening is spaced apart from the first fastener opening along the length of the splice plate, wherein the second fastener opening is configured to receive a second fastener to fasten the splice plate to the second cable tray section; and
spacing indicia configured to indicate to a user longitudinal spacing between the longitudinal ends of the first and second cable tray sections when the splice plate is fastened to the first and second cable tray sections.

2. The splice plate set forth in claim 1, wherein the spacing indicia comprises at least one marking configured to be alignable with at least one of the longitudinal ends of the first and second cable tray sections.

3. The splice plate set forth in claim 2, wherein the at least one marking comprises calibrated markings spaced apart along the length of the splice plate.

4. The splice plate set forth in claim 3, wherein the calibrated markings comprise lines.

5. The splice plate set forth in claim 3, wherein the spacing indicia further comprises unit of length markings associated with the calibrated markings.

6. The splice plate set forth in claim 1, wherein the spacing indicia is on the plate body.

7. The splice plate set forth in claim 6, wherein the splice plate further includes a window adjacent the spacing indicia and extending through the inboard and outboard faces of the plate body.

8. The splice plate set forth in claim 8, wherein at least a portion of the spacing indicia is disposed between the first and second fastener openings relative to the length of the splice plate.

9. The splice plate set forth in claim 8, wherein the window is partially defined by upper and lower edges extending lengthwise of the splice plate, wherein at least one of the upper and lower edges are stepped shaped.

10. The splice plate set forth in claim 8, wherein the window is defined by overlapping circular openings extending lengthwise of the splice plate.

11. The splice plate set forth in claim 8, wherein the window is defined by a series of spaced apart openings extending lengthwise of the splice plate.

12. The splice plate set forth in claim 1, wherein at least a portion of the spacing indicia is disposed between the first and second fastener openings relative to the length of the splice plate.

13. The splice plate set forth in claim 14, wherein at least one of the first and second fastener openings has a slot shape extending lengthwise of the splice plate.

14. The splice plate set forth in claim 1, further comprising a notification marking indicating to the user that first and second cable tray sections should be spaced apart longitudinally when spliced together using the splice plate.

15. The splice plate set forth in claim 1, further comprising a machine readable marking including a machine readable representation of a web address that directs a hand-held device including a processor to a webpage including instructions for using the splice plate.

16. A splice plate for splicing together longitudinal ends of respective first and second cable tray sections to form a cable tray run, the splice plate having opposite first and second longitudinal ends and a length extending therebetween, the splice plate comprising:
a plate body having opposite inboard and outboard faces;
a first fastener opening extending through the inboard and outboard faces of the plate body, wherein the first fastener opening is configured to receive a first fastener to fasten the splice plate to the first cable tray section;
a second fastener opening extending through the inboard and outboard faces of the plate body, wherein the second opening is spaced apart from the first fastener opening along the length of the splice plate, wherein the second fastener opening is configured to receive a second fastener to fasten the splice plate to the second cable tray section; and
a window configured to allow at least one of the longitudinal ends of the respective first and second cable tray sections to be visible therethrough when the splice plate is fastened to the first and second cable tray sections.

17. The splice plate set forth in claim 18, further comprising spacing indicia configured to indicate to a user longitudinal spacing between the longitudinal ends of the first and second cable tray sections when the splice plate is fastened to the first and second cable tray sections.

18. The splice plate set forth in claim 18, wherein each of the longitudinal ends of the respective first and second cable tray sections capable of being visible through the window when the splice plate is fastened to the first and second cable tray sections.

19. A splice plate for splicing together longitudinal ends of respective first and second cable tray sections to form a cable tray run, the splice plate having opposite first and second longitudinal ends and a length extending therebetween, the splice plate comprising:
a plate body having opposite inboard and outboard faces;
a first fastener opening extending through the inboard and outboard faces of the plate body, wherein the first fastener opening is configured to receive a first fastener to fasten the splice plate to the first cable tray section;
a second fastener opening extending through the inboard and outboard faces of the plate body, wherein the second opening is spaced apart from the first fastener opening along the length of the splice plate and is configured to receive a second fastener to fasten the splice plate to the second cable tray section, wherein at least one of the first and second fastener openings is slot-shaped having a length extending lengthwise of the splice plate;
a machine readable marking including a machine readable representation of a web address that directs a hand-held device including a processor to a webpage including instructions for using the splice plate.

20. The splice plate set forth in claim 19, wherein the machine readable marking comprises a barcode.
